(19) United States
(12) Patent Application Publication
(10) Pub. No.: US 2025/0256703 A1
(43) Pub. Date: Aug. 14, 2025

(54) METHOD AND APPARATUS FOR ACTIVATING ESC OF INTELLIGENT DRIVING VEHICLE

(71) Applicant: Shenzhen Yinwang Intelligent Technologies Co., Ltd., Shenzhen (CN)

(72) Inventors: Kai YU, Shenzhen (CN); Yongyou ZHOU, Shanghai (CN); Guangyi WANG, Shenzhen (CN); Mingze LING, Shanghai (CN)

(21) Appl. No.: 19/196,611

(22) Filed: May 1, 2025

Related U.S. Application Data
(63) Continuation of application No. PCT/CN2022/129495, filed on Nov. 3, 2022.

(51) Int. Cl. B60W 30/02; B60W 50/14; B60W 60/00

(52) U.S. Cl. CPC B60W 30/02; B60W 50/14; B60W 60/007; B60W 2710/0666; B60W 2710/18; B60W 2710/20

(57) ABSTRACT

This application discloses a method and an apparatus for activating an ESC of an intelligent driving vehicle. In this method, an ESC activation probability is obtained after an intelligent driving function of the intelligent driving vehicle is enabled. A pre-exit signal of an ADS and a warning signal are outputted when the ESC activation probability is greater than a preset latch interval. The pre-exit signal indicates the ADS to maintain stability of a traveling status of the intelligent driving vehicle. The warning signal prompts a driver to take over the intelligent driving vehicle. A stability parameter of the intelligent driving vehicle is obtained, where the stability parameter represents a stability characteristic of the traveling status of the intelligent driving vehicle. When the stability parameter meets an ESC activation condition, the ESC of the intelligent driving vehicle is activated.

### CROSS-REFERENCE TO RELATED APPLICATIONS

This application is a continuation of International Application No. PCT/CN2022/129495, filed on Nov. 3, 2022, the disclosure of which is hereby incorporated by reference in its entirety.

### TECHNICAL FIELD

This application relates to the field of intelligent driving technologies, and in particular, to a method and an apparatus for activating an ESC of an intelligent driving vehicle.

### BACKGROUND

With the development of intelligent driving technologies, vehicles with intelligent driving capabilities become increasingly popular. Due to weather reasons such as rain and snow, a vehicle whose intelligent driving function is enabled and that travels on a wet and slippery road may be in dangerous working conditions such as vehicle understeering or oversteering due to reasons such as inconsistency between a driving torque requested by an autonomous driving system (ADS) during steering and a road adhesion condition. In this case, a chassis electronic stability controller (ESC) is activated.

In the conventional technology, a security and stability boundary of steering is calculated based on current information, and a steering/braking actuator is controlled within an actual stability boundary. By default, an ESC is not triggered or a probability of triggering the ESC is low. However, after the ESC is activated, an intelligent driving function directly exits. A driver cannot respond, in time, to an emergency case in which the ADS directly exits or takes over a vehicle when the vehicle is unstable, which poses a safety risk.

### SUMMARY

This application provides a method and an apparatus for activating a chassis electronic stability controller ESC of an intelligent driving vehicle, to control a traveling status of the vehicle before the ESC of the vehicle is enabled, and reduce a safety risk of taking over the vehicle by a driver.

According to a first aspect, this application provides a method for activating an ESC of an intelligent driving vehicle. The following uses a vehicle management module that performs activation management on the ESC of the intelligent driving vehicle as an execution body, and the method includes the following operations.

The vehicle management module obtains an ESC activation probability after an intelligent driving function of the vehicle is enabled; and the vehicle management module outputs a pre-exit signal of an autonomous driving system ADS and a warning signal when the ESC activation probability is greater than a preset latch interval. The pre-exit signal indicates the ADS to maintain stability of a traveling status of the vehicle, and the warning signal prompts a driver to take over the vehicle. Then, the vehicle management module obtains a stability parameter of the vehicle. The stability parameter represents a stability characteristic of the traveling status of the vehicle. The vehicle management module activates the ESC when the stability parameter meets an ESC activation condition.

In this method, after intelligent driving of the vehicle is enabled, the vehicle management module obtains the ESC activation probability, and determines whether the ESC activation probability is greater than the latch interval. When the ESC activation probability is greater than the latch interval, the vehicle management module outputs the pre-exit signal that indicates the ADS to maintain stability of the traveling status of the vehicle, and simultaneously outputs the warning signal that prompts the driver to take over the vehicle. This gives the driver a reaction time. In addition, when it is determined that the obtained stability parameter of the vehicle meets the ESC activation condition, the ESC is activated, so that the driver can safely take over the vehicle after the ESC is activated, to reduce a safety risk of taking over the vehicle by the driver during vehicle mode switching.

In an embodiment, the vehicle management module obtains traveling data of the vehicle, and determines the ESC activation probability based on the traveling data.

In this design, the vehicle management module can accurately determine the activation probability of the ESC based on the traveling data.

In an embodiment, the vehicle management module determines an activation factor based on the traveling data. The activation factor includes at least one parameter of a focus degree, a vehicle status parameter, and a road adhesion coefficient. The focus degree represents a capability of the driver to take over the vehicle after the ADS exits. Then, the vehicle management module determines the ESC activation probability based on the activation factor.

In this design, the vehicle management module can accurately determine the ESC activation probability based on the at least one parameter of the focus degree, the vehicle status parameter, and the road adhesion coefficient.

In an embodiment, the vehicle management module performs weight normalization on the activation factor, to obtain the ESC activation probability.

In an embodiment, the vehicle management module sends the pre-exit signal to the ADS, and determines that the vehicle enters an ADS pre-exit phase, and adjusts a steering direction, a driving torque, and a braking torque of the vehicle by using the ADS, to control the traveling status of the vehicle to be in a stable deceleration status.

In this design, in the ADS pre-exit phase, the vehicle management module adjusts the steering direction, the driving torque, and the braking torque of the vehicle by using the ADS, to control the traveling status of the vehicle to be in the stable deceleration status, so as to control the vehicle to be stable, and provide safety assurance for the driver to take over the vehicle subsequently.

In an embodiment, after outputting the pre-exit signal and the warning signal, the vehicle management module determines whether the ESC activation probability is less than the latch interval. In addition, the vehicle management module obtains the stability parameter when the ESC activation probability is greater than the latch interval, or the ESC activation probability is within the latch interval. The vehicle management module collects statistics on duration in which the ESC activation probability is less than the latch interval when determining that the ESC activation probability is less than the latch interval, and stops outputting the pre-exit signal and the warning signal when the duration is greater than a time threshold.

In this design, after the vehicle management module outputs the pre-exit signal and the warning signal, the vehicle enters the ADS pre-exit phase, and in this phase, the vehicle management module controls the vehicle to be in the stable deceleration status, and determines whether the ESC activation probability in the pre-exit phase is less than the latch interval. When determining that the ESC activation probability is not less than the latch interval, the vehicle management module obtains the stability parameter, to determine whether to activate the ESC to maintain stability of the vehicle. When determining that the ESC activation probability is less than the latch interval, the vehicle management module determines that the vehicle gradually tends to be stable under the control of the ADS. In this case, the vehicle management module collects statistics on the duration in which the ESC activation probability is less than the latch interval. When determining that the duration is greater than the time threshold, the vehicle management module determines that the ADS controls the vehicle to restore stability again, and stops outputting the pre-exit signal and the warning signal, and the vehicle restores to the intelligent driving mode.

In an embodiment, the vehicle management module activates the ESC, determines that the vehicle enters an ESC activation phase, and simultaneously exits the ADS. In the ESC activation phase, the vehicle management module adjusts the steering direction, the driving torque, and the braking torque of the vehicle by using the ESC, to control the traveling status of the vehicle to be in the stable deceleration status. In addition, the vehicle management module obtains the stability parameter, and determines whether the stability parameter meets a stability condition. The vehicle management module exits the ESC after determining that the stability parameter meets the stability condition.

In this design, in the ESC activation phase, the vehicle management module adjusts the steering direction, the driving torque, and the braking torque of the vehicle by using the ESC, to control the traveling status of the vehicle to be in the stable deceleration status, so that the vehicle can restore stability, and a safe traveling environment is provided for the driver to take over the vehicle.

In an embodiment, after exiting the ESC, the vehicle management module adjusts the steering direction, the driving torque, and the braking torque of the vehicle, controls the traveling status of the vehicle to be in the stable deceleration status, and determines whether the driver takes over the vehicle in a warning time period after the warning signal is output. The vehicle management module controls the vehicle to brake when determining that the driver does not take over the vehicle in the warning time period.

In this design, after exiting the ESC, the vehicle management module controls the vehicle to be in the stable deceleration status, to provide safety assurance for the driver to take over the vehicle. After determining that the driver does not take over the vehicle within the warning time period, the vehicle management module controls the vehicle to brake, so as to ensure driving safety and avoid an accident.

According to a second aspect, this application provides an apparatus for activating an ESC of an intelligent driving vehicle, where the apparatus includes:
a first obtaining unit, configured to obtain an ESC activation probability after an intelligent driving function of the vehicle is enabled;
an output unit, configured to output a pre-exit signal of an autonomous driving system ADS and a warning signal when the ESC activation probability is greater than a preset latch interval, where the pre-exit signal indicates the ADS to maintain stability of a traveling status of the vehicle, and the warning signal prompts a driver to take over the vehicle;
a second obtaining unit, configured to obtain a stability parameter of the vehicle, where the stability parameter represents a stability characteristic of the traveling status of the vehicle; and
an activation unit, configured to activate the ESC when the stability parameter meets an ESC activation condition.

In an embodiment, the first obtaining unit is configured to:
obtain traveling data of the vehicle; and
determine the ESC activation probability based on the traveling data.

In an embodiment, the first obtaining unit is configured to:
determine an activation factor based on the traveling data, where the activation factor includes at least one parameter of a focus degree, a vehicle status parameter, and a road adhesion coefficient, and the focus degree represents a capability of the driver to take over the vehicle after the ADS exits; and
determine the ESC activation probability based on the activation factor.

In an embodiment, the first obtaining unit is configured to:
perform weight normalization on the activation factor, to obtain the ESC activation probability.

In an embodiment, the output unit is configured to:
send the pre-exit signal to the ADS, and determine that the vehicle enters an ADS pre-exit phase; and
adjust a steering direction, a driving torque, and a braking torque of the vehicle by using the ADS, to control the traveling status of the vehicle to be in a stable deceleration status.

In an embodiment, after the pre-exit signal of the autonomous driving system ADS and the warning signal are output, the second obtaining unit is further configured to:
determine whether the ESC activation probability is less than the latch interval; and
obtain the stability parameter if the ESC activation probability is greater than the latch interval, or the ESC activation probability is within the latch interval; or
collect statistics on duration in which the ESC activation probability is less than the latch interval if the ESC activation probability is less than the latch interval; and stop outputting the pre-exit signal and the warning signal when the duration is greater than a time threshold.

In an embodiment, the activation unit is configured to:
activate the ESC, determine that the vehicle enters an ESC activation phase, and exit the ADS;
adjust the steering direction, the driving torque, and the braking torque of the vehicle by using the ESC in the ESC activation phase, to control the traveling status of the vehicle to be in the stable deceleration status; and
obtain the stability parameter, and determine whether the stability parameter meets a stability condition; and exit the ESC if the stability parameter meets the stability condition.

In an embodiment, after exiting the ESC, the activation unit is further configured to:
adjust the steering direction, the driving torque, and the braking torque of the vehicle, to control the traveling status of the vehicle to be in the stable deceleration status;
determine whether the driver takes over the vehicle within a warning time period after the warning signal is output; and
control the vehicle to brake if the driver does not take over the vehicle within the warning time period.

According to a third aspect, this application provides an electronic device applied to an intelligent driving vehicle. The electronic device includes a processor and a memory. The memory stores one or more computer programs, and the one or more computer programs include instructions. When the processor invokes the instructions, a communication apparatus is enabled to perform the method for activating an ESC of an intelligent driving vehicle according to the first aspect.

According to a fourth aspect, this application provides an intelligent driving vehicle. The intelligent driving vehicle includes an ESC, an ADS, and the ESC activation apparatus according to the second aspect. When the ADS is activated, the ESC activation apparatus performs the method according to the first aspect or any one of the possible implementations of the first aspect.

According to a fifth aspect, this application provides a computer-readable storage medium. The computer-readable storage medium stores a computer program or instructions. When the computer program or the instructions are executed, a computer is enabled to perform the method according to the first aspect or any one of the possible implementations of the first aspect.

According to a sixth aspect, this application provides a computer program product. When a computer executes the computer program product, the computer is enabled to perform the method according to the first aspect or any one of the possible implementations of the first aspect.

For beneficial effects of the second aspect to the fourth aspect, refer to the description of the beneficial effects of the first aspect. Details are not described herein again.

### BRIEF DESCRIPTION OF DRAWINGS

FIG. 1 is a schematic flowchart of a possible method for activating an ESC of an intelligent driving vehicle in a solution according to an embodiment of this application;

FIG. 2 is a schematic diagram of a possible vehicle traveling status in a solution according to an embodiment of this application;

FIG. 3 is a schematic diagram of another possible vehicle traveling status in a solution according to an embodiment of this application;

FIG. 4 is a schematic diagram of still another possible vehicle traveling status in a solution according to an embodiment of this application;

FIG. 5A to FIG. 5C are a complete schematic flowchart of a possible method for activating an ESC of an intelligent driving vehicle in a solution according to an embodiment of this application;

FIG. 6 is a schematic diagram of a structure of a possible ESC activation system in a solution according to an embodiment of this application;

FIG. 7 is a schematic diagram of a structure of an apparatus for activating an ESC of an intelligent driving vehicle in a solution according to an embodiment of this application;

FIG. 8 is a schematic diagram of a structure of an electronic device in a solution according to an embodiment of this application; and

FIG. 9 is a schematic diagram of a structure of an intelligent driving vehicle in a solution according to an embodiment of this application.

### DETAILED DESCRIPTION

Embodiments of this application provide a method and an apparatus for activating an ESC of an intelligent driving vehicle. The method and the apparatus are based on the same idea. Because principles for resolving problems by using the method and the apparatus are similar, implementations of the apparatus and the method can be mutually used, and repeated descriptions are not provided herein again.

To make objectives, technical solutions, and advantages of embodiments of this application clearer, the following further describes embodiments of this application in detail with reference to accompanying drawings. The terms “first” and “second” below in descriptions of embodiments of this application are merely used for a description purpose, and shall not be understood as an indication or implication of relative importance or implicit indication of a quantity of indicated technical features. Therefore, a characteristic limited by “first” or “second” may explicitly or implicitly indicate that one or more characteristics are included.

For ease of understanding, examples of descriptions of concepts related to this application are provided for reference.
(1) A chassis electronic stability controller (ESC) is a new type of active safety system of a vehicle, and is a further extension of functions of an antilock brake system (ABS) and a traction control system (TCS) of a vehicle. On this basis, a yaw rate sensor, a lateral acceleration sensor, and a steering wheel angle sensor are added that are used when the vehicle is being steered. Driving torques and braking torques of front and rear wheels and left and right wheels are controlled by an electronic control unit, to ensure lateral stability during traveling of the vehicle.
(2) A road adhesion coefficient is a ratio of an adhesion force to a normal (a direction perpendicular to a road) pressure of a wheel. In rough calculation, the road adhesion coefficient may be regarded as a static friction coefficient between a tire and the road. The road adhesion coefficient is determined by the road and the tire. A larger coefficient indicates a larger adhesion force that can be used and a smaller possibility that the vehicle slips.

In descriptions of embodiments of this application, the term “and/or” describes an association relationship between associated objects and indicates that three relationships may exist. For example, A and/or B may indicate the following three cases: Only A exists, both A and B exist, and only B exists. The character “/” generally indicates an “or” relationship between the associated objects. In this application, “at least one” means one or more, and “a plurality of” means two or more. In addition, it should be understood that, in the description of this application, vocabularies such as “first” and “second” are merely used for distinguishing and description, but should not be understood as indicating or implying relative importance, or should not be understood as indicating or implying a sequence. The following describes embodiments of this application in detail with reference to the accompanying drawings.

In the conventional technology, a security and stability boundary of steering is calculated based on current information, and a steering/braking actuator is controlled within an actual stability boundary. By default, an ESC is not triggered or a probability of triggering the ESC is low. However, after the ESC is activated, an intelligent driving function directly exits. A driver cannot respond, in time, to an emergency case in which the ADS directly exits or takes over a vehicle when the vehicle is unstable, which poses a safety risk.

In order to reduce a safety risk of taking over a vehicle by a driver after the ESC is activated, an embodiment of this application provides a method for activating an ESC of an intelligent driving vehicle. The following uses, as an execution body, a vehicle management module that performs activation management on the ESC of the intelligent driving vehicle for description. In this method, the vehicle management module obtains an ESC activation probability after an intelligent driving function of the vehicle is enabled; and the vehicle management module outputs a pre-exit signal of an autonomous driving system (ADS) and a warning signal when the ESC activation probability is greater than a preset latch interval. The pre-exit signal indicates the ADS to maintain stability of a traveling status of the vehicle, and the warning signal prompts a driver to take over the vehicle. Then, the vehicle management module obtains a stability parameter of the vehicle. The stability parameter represents a stability characteristic of the traveling status of the vehicle. The vehicle management module activates the ESC when the stability parameter meets an ESC activation condition.

The following describes the solutions provided in this application with reference to the accompanying drawings and specific embodiments.

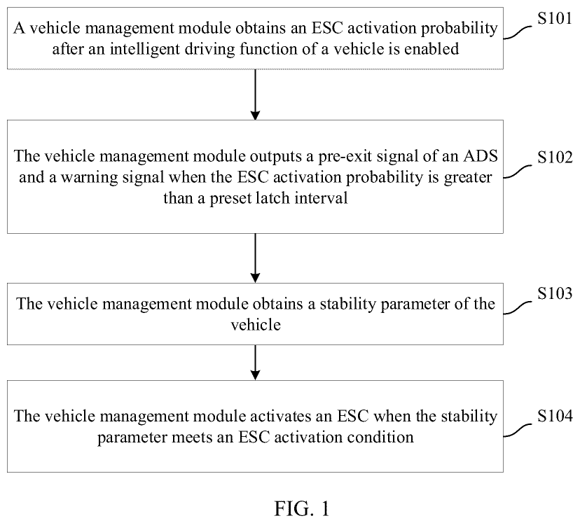

FIG. 1 is a schematic diagram of a method for activating an ESC of an intelligent driving vehicle according to an embodiment of this application. The following uses, as an execution body, a vehicle management module that performs activation management on the ESC of the intelligent driving vehicle for description. As shown in FIG. 1, the method includes the following operations.

S101: The vehicle management module obtains an ESC activation probability after an intelligent driving function of the vehicle is enabled.

In an embodiment, after determining that the intelligent driving function of the vehicle is enabled, the vehicle management module obtains traveling data of the vehicle, and determines the ESC activation probability based on the obtained traveling data.

In some embodiments, the traveling data includes but is not limited to: operation input information of a driver, vehicle status information obtained by a vehicle sensor, a driver image collected by an in-vehicle camera, and a road image and an environment image collected by a camera outside the vehicle. The operation input information of the driver includes but is not limited to: a steering wheel angle, a throttle pedal stroke, and a brake pedal stroke. The vehicle status information obtained by the sensor includes but is not limited to: horizontal and longitudinal accelerations, a wheel speed, a vehicle speed, a yaw angular velocity, a side-slip angle, and a wheel slip rate.

In an embodiment, the vehicle management module may perform S101 by using the following operations:

A1: The vehicle management module determines an activation factor based on the traveling data.

The activation factor includes at least one parameter of a focus degree, a vehicle status parameter, and a road adhesion coefficient. The focus degree represents a capability of the driver to take over the vehicle after the ADS exits.

The vehicle management module may determine the activation factor in the following manner.

In some embodiments, the vehicle management module determines the focus degree of the driver based on the driver image in the traveling data.

In an embodiment, the vehicle management module may input the obtained driver image into a trained image recognition model, extract a feature from the image based on the trained image recognition model, to obtain a facial feature parameter, and determine the focus degree based on the facial feature parameter.

In an embodiment, the vehicle management module may determine the focus degree of the driver based on a correspondence between a facial feature parameter and a focus degree. When there are a plurality of facial feature parameters, a sum of focus degrees corresponding to the plurality of facial feature parameters is used as a current focus degree of the driver.

In some embodiments, the vehicle management module determines the vehicle status parameter based on the vehicle status information in the traveling data. The vehicle status parameter includes at least one parameter of a slip rate, a side-slip angle deviation, a yaw angular velocity deviation, and a lateral acceleration.

In an embodiment, the vehicle management module may determine the vehicle status parameter in the following manner.

In some embodiments, the vehicle management module may determine slip rates of wheels based on the wheel speed and the vehicle speed in the vehicle status information, and use a largest value of the slip rates of the wheels as a first slip rate. The vehicle management module uses a maximum value of the wheel slip rate in the vehicle status information as a second slip rate. The vehicle management module uses, as the vehicle status parameter, a slip rate obtained by combining the first slip rate and the second slip rate by using a Kalman filtering method.

In some embodiments, the vehicle management module may use the lateral acceleration in the vehicle status information as the vehicle status parameter.

In some embodiments, the vehicle management module may determine a lateral vehicle speed and a longitudinal vehicle speed of the vehicle based on the vehicle status information, and determine an actual side-slip angle of the vehicle in a current status based on the determined longitudinal vehicle speed and the determined lateral vehicle speed. The vehicle management module may further input the vehicle status information into a linear 2-degree-of-freedom vehicle model, and obtain an ideal side-slip angle based on the linear 2-degree-of-freedom vehicle model. The vehicle management module uses a difference between the actual side-slip angle and the ideal side-slip angle as the side-slip angle deviation.

In an embodiment, in this embodiment of this application, the vehicle management module may select the linear 2-degree-of-freedom vehicle model as a reference model, and use a centroid side-slip angle β when the vehicle enters a stable status as a reference value. To ensure stable traveling of the vehicle, an upper limit value of a centroid side-slip angle is limited by the vehicle model to |βₘₐₓ|=μg(b/u²+ma/k₂L), and the smaller value min{β, |βₘₐₓ|} in β and |βₘₐₓ| is used as the ideal side-slip angle.

μ represents a road adhesion coefficient in the vehicle status information; a represents a distance from a front axle to a centroid; b represents a distance from a rear axle to the centroid; k₂ represents cornering stiffness of a rear wheel; g represents a gravity acceleration; m represents a vehicle weight; and L represents a distance between rear wheels.

In some embodiments, the vehicle management module uses the yaw angular velocity in the vehicle status information as an actual yaw angular velocity. The vehicle management module inputs the vehicle status information into a vehicle model, and determines an ideal yaw angular velocity based on the vehicle model. The vehicle management module uses a difference between the actual yaw angular velocity and the ideal yaw angular velocity as the yaw angular velocity deviation.

In an embodiment, the vehicle management module may input the vehicle status information into the linear 2-degree-of-freedom vehicle model, use a yaw angular velocity ω when the vehicle enters the stable status as a reference value, and limit an upper limit value of the yaw angular velocity to |ωₘₐₓ|=0.85 μg/Vₓ based on the vehicle model. μ represents the road adhesion coefficient in the vehicle status information, Vₓ represents a longitudinal vehicle speed, and g represents the gravity acceleration. The vehicle model uses the smaller value min{ω, |ωₘₐₓ|} of ω and |ωₘₐₓ| as the ideal yaw angular velocity, and outputs the ideal yaw angular velocity.

In some embodiments, the vehicle management module determines the road adhesion parameter based on the road image and the vehicle status information.

In an embodiment, the vehicle management module may input the road image into a convolutional neural network, extract a feature from the road image based on the convolutional neural network, to obtain a road feature, and determine a first road adhesion coefficient based on the road feature. The convolutional neural network is obtained through training in advance based on a historical road image and a historical road adhesion coefficient corresponding to the historical road image.

The vehicle management module may determine a second road adhesion coefficient based on the vehicle status information by using a three-degree-of-freedom dynamic equation of the vehicle.

In an embodiment, the vehicle management module may normalize tire forces based on the vehicle status information and a dugoff tire model, and determine the second road adhesion coefficient by using an EKF method and based on the three-degree-of-freedom dynamic equation.

The vehicle management module determines the road adhesion coefficient based on the first road adhesion coefficient and the second road adhesion coefficient, and uses the road adhesion coefficient as the vehicle status parameter.

In an embodiment, the vehicle management module may combine the first road adhesion coefficient and the second road adhesion coefficient into the road adhesion coefficient by using a fuzzy theory.

A2: The vehicle management module determines the ESC activation probability based on the activation factor.

In A2, the vehicle management module may perform weight normalization on the activation factor to obtain the ESC activation probability.

In some embodiments, the vehicle management module may determine the ESC activation probability by using the following formula:

$${P}_{act} ( ESC ) = \text{} \frac{\begin{matrix}{α}_{0} {f}_{0} ( λ ) + {α}_{1} {f}_{1} ( {a}_{y} ) + {α}_{2} {f}_{2} ( Δ β ) + \\ {α}_{3} {f}_{3} ( Δω ) + {α}_{4} {f}_{4} ( μ ) + {α}_{5} {f}_{5} ( {x}_{1} , {x}_{2} … )\end{matrix}}{{\sum }_{0}^{5} {α}_{i}}$$

P_{act} (ESC) represents the ESC activation probability, P_{act}(ESC)∈[0, 1], α0, α1, α2, α3, α4, and α5 represent weight parameters, f₀(λ) represents a normalized slip rate, f₁(a_{y}) represents a normalized lateral acceleration, f₂(Δβ) represents a normalized side-slip angle deviation, f₃(Δω) represents a normalized yaw angular velocity deviation, f₄(μ) represents a normalized road adhesion parameter, f₅(x₁, x₂ . . . ) represents a normalized focus degree, and x₁ and x₂ represent facial feature parameters of the driver.

S102: The vehicle management module outputs a pre-exit signal of the ADS and a warning signal when the ESC activation probability is greater than a preset latch interval. The pre-exit signal indicates the ADS to maintain stability of a traveling status of the vehicle, and the warning signal prompts the driver to take over the vehicle.

After determining the ESC activation probability, the vehicle management module determines whether the ESC activation probability is greater than the preset latch interval.

In some embodiments, if the ESC activation probability is less than the latch interval, the vehicle management module determines that a probability of activating the ESC of the vehicle in a current status is not high, and continues to obtain the traveling data to determine the ESC activation probability.

In some other embodiments, if the ESC activation probability is within the latch interval, the vehicle management module determines that the ESC of the vehicle may be activated in the current status, keeps output enabling of the pre-exit signal, and continues to obtain the traveling data to determine the ESC activation probability.

When determining that the ESC activation probability is within the latch interval, the vehicle management module keeps the output enabling of the pre-exit signal, so as to avoid oscillation of an enabling fluctuation bit of the pre-exit signal when the ESC activation probability fluctuates near a threshold of the latch interval. In addition, when determining that the ESC activation probability is greater than the latch interval, the vehicle management module can output the pre-exit signal in time.

In some other embodiments, the vehicle management module outputs the pre-exit signal and the warning signal if the ESC activation probability is greater than the latch interval.

In an embodiment, the warning signal output by the vehicle management module includes but is not limited to: a seat shake signal, a voice prompt signal, and an image prompt signal. For example, the vehicle management module outputs the seat shake signal, and controls a seat to shake, to prompt the driver to take over the vehicle. The vehicle management module may output the voice prompt signal to prompt the driver to take over the vehicle. The vehicle management module may further output the image prompt signal on a display interface of the vehicle to prompt the driver to take over the vehicle.

In an embodiment, the vehicle management module may increase a strength and a frequency of the warning signal as an output time of the warning signal increases, to better prompt the driver to take over the vehicle.

For example, when determining that the ESC activation probability is greater than the latch interval, the vehicle management module outputs the seat shake signal, and prompts, by shaking the seat, the driver to take over the vehicle. If the driver does not take over the vehicle within 30 seconds after the seat shake signal is output, the vehicle management module adjusts the seat shake signal to increase a frequency of the seat shake, so as to prompt the driver to take over the vehicle as soon as possible.

In an embodiment, the vehicle management module may output the pre-exit signal in S102 in the following operations:

B1: The vehicle management module sends the pre-exit signal to the ADS, and determines that the vehicle enters an ADS pre-exit phase.

In some embodiments, the vehicle management module sends the pre-exit signal to the ADS, to notify the ADS that the ESC of the vehicle is about to be activated. After receiving the pre-exit signal, the ADS may maintain stability of the traveling status of the vehicle, to prevent the vehicle management module from activating the ESC.

B2: The vehicle management module adjusts a steering direction, a driving torque, and a braking torque of the vehicle by using the ADS, to control the traveling status of the vehicle to be in a stable deceleration status.

In an embodiment, when sending the pre-exit signal to the ADS, the vehicle management module may further send ESC activation information to the ADS. The ADS may adjust the steering direction, the driving torque, and the braking torque of the vehicle based on the ESC activation information, to control the traveling status of the vehicle to be in the stable deceleration status.

In some embodiments, the vehicle management module may adjust the steering direction, the driving torque, and the braking torque of the vehicle by using the ADS, to control the traveling status of the vehicle to be in the stable deceleration status, so as to maintain stability of the traveling status of the vehicle, thereby preventing the vehicle management module from activating the ESC to maintain stability of the vehicle.

In some embodiments, after outputting the pre-exit signal and the warning signal, the vehicle management module may further determine whether the ESC activation probability is less than the latch interval.

In the ADS pre-exit phase, the vehicle management module continues to determine the ESC activation probability, and determines whether the ESC activation probability is less than the latch interval.

In some embodiments, if the ESC activation probability is less than the latch interval, statistics are collected on duration in which the ESC activation probability is less than the latch interval. The vehicle management module stops outputting the pre-exit signal and the warning signal when the duration is greater than a time threshold.

When the ESC activation probability is less than the latch interval, the vehicle management module determines that the traveling status of the vehicle gradually tends to be stable. The vehicle management module continues to determine the ESC activation probability, and collects statistics on the duration in which the ESC activation probability is less than the latch interval.

In an embodiment, when determining that the duration in which the ESC activation probability is less than the latch interval is greater than the time threshold, the vehicle management module determines that the traveling status of the vehicle already tends to be stable, and stops outputting the pre-exit signal and the warning signal. In this case, the vehicle management module determines to continue to use the intelligent driving function for the vehicle.

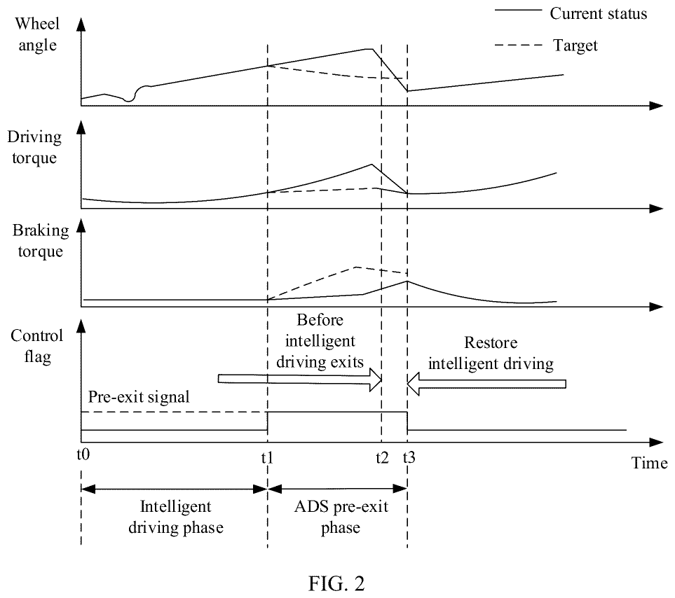

For example, as shown in FIG. 2, an embodiment of this application provides a schematic diagram of a traveling status of a vehicle. At a moment t0, the vehicle is in an intelligent driving phase, and the ADS normally takes over the vehicle. The vehicle management module imposes no limitation on the ADS, and the vehicle management module does not output the enabling flag bit of the pre-exit signal. In addition, under control of the ADS in the intelligent driving phase, no braking torque is applied to the vehicle, and a driving torque and a wheel angle of the vehicle gradually tend to increase. At a moment t1, after determining that the ESC activation probability is greater than the latch interval, the vehicle management module outputs the enabling flag bit of the pre-exit signal, and determines that the vehicle enters the ADS pre-exit phase. In the ADS pre-exit phase, taking over the vehicle by the ADS is limited by the vehicle management module. After receiving the pre-exit signal, the ADS performs a limiting measure. The limiting measure includes but is not limited to: limiting a further increase of the wheel angle, limiting a further increase of the driving torque, gradually increasing the braking torque, and slowly decelerating. In the ADS pre-exit phase, the ADS performs the limiting measure, so that the wheel angle and the driving torque each change from a previous situation in which a current value is greater than a target value to a situation in which the current value is not greatly different from the target value, so that the vehicle management module determines, at a moment t2, that the ESC activation probability is less than the latch interval. After the moment t2, the ADS still performs the limiting measure, so that the ESC activation probability determined by the vehicle management module at a moment t3 is still less than the latch interval. That is, in a time period from the moment t2 to the moment t3, the ESC activation probability is always less than the latch interval. When the time period between t2 and t3 reaches the duration in which the ESC activation probability is less than the latch interval, the vehicle management module stops outputting the pre-exit signal at the moment t3, and the vehicle re-enters the intelligent driving phase.

In some other embodiments, the vehicle management module obtains a stability parameter when the ESC activation probability is greater than the latch interval, or the ESC activation probability is within the latch interval.

In the ADS pre-exit phase, when determining that the ESC activation probability is greater than the latch interval or the ESC activation probability is within the latch interval, the vehicle management module determines that the vehicle is still in an unstable status after the ADS maintains stability of the traveling status of the vehicle. The vehicle management module obtains the stability parameter, and determines whether the ESC needs to be activated to maintain stability of the traveling status of the vehicle.

S103: The vehicle management module obtains the stability parameter of the vehicle, where the stability parameter represents a stability characteristic of the traveling status of the vehicle.

In some embodiments, the stability parameter includes but is not limited to: the yaw angular velocity and the centroid side-slip angle. The vehicle management module may obtain the stability parameter by using an existing stability parameter obtaining method, or may obtain the stability parameter in another manner. This is not limited in this embodiment of this application.

S104: The vehicle management module activates the ESC when the stability parameter meets an ESC activation condition.

In some embodiments, the vehicle management module determines whether the obtained stability parameter meets the ESC activation condition. The ESC activation condition may be a condition under which the vehicle is in an unstable status. For example, the ESC activation condition may be that a moving track of the vehicle does not match an expected track of the intelligent driving function, or the vehicle has an insufficient steering trend, or the vehicle has an excessive steering trend.

In an embodiment, if the stability parameter does not meet the ESC activation condition, the vehicle management module determines the ESC activation probability, and determines whether the ESC activation probability is less than the latch interval.

In an embodiment, the vehicle management module activates the ESC if the stability parameter meets the ESC activation condition.

In some embodiments, when determining that the stability parameter meets the ESC activation condition, the vehicle management module activates the ESC, determines that the vehicle enters an ESC activation phase, and exits the ADS.

When determining that the stability parameter meets the ESC activation condition, the vehicle management module determines that the traveling status of the vehicle is in an unstable status, and activates the ESC, to control, by using the ESC, the traveling status of the vehicle to restore to the stable status.

In some embodiments, in the ESC activation phase, the vehicle management module adjusts the steering direction, the driving torque, and the braking torque of the vehicle by using the ESC, to control the traveling status of the vehicle to be in the stable deceleration status.

The vehicle management module obtains the stability parameter in the ESC activation phase and determines whether the stability parameter meets a stability condition. If the stability parameter meets the stability condition, the vehicle management module exits the ESC.

In some embodiments, after exiting the ESC, the vehicle management module adjusts the steering direction, the driving torque, and the braking torque of the vehicle, to control the traveling status of the vehicle to be in the stable deceleration status.

When the vehicle is in the stable deceleration status, the vehicle management module determines whether the driver takes over the vehicle within a warning time period after the warning signal is output.

In some embodiments, the vehicle management module controls the vehicle to brake if the driver does not take over the vehicle within the warning time period.

When the driver does not take over the vehicle within the warning time period, the vehicle management module obtains the traveling data, determines a distance between the vehicle and an obstacle in front of the vehicle, and determines, based on the distance, a braking pressure value used for maintaining stable braking of the vehicle. The vehicle management module sends the braking pressure value to a hydraulic unit, so that the hydraulic unit adjusts braking pressure to the braking pressure value, to control the vehicle to brake.

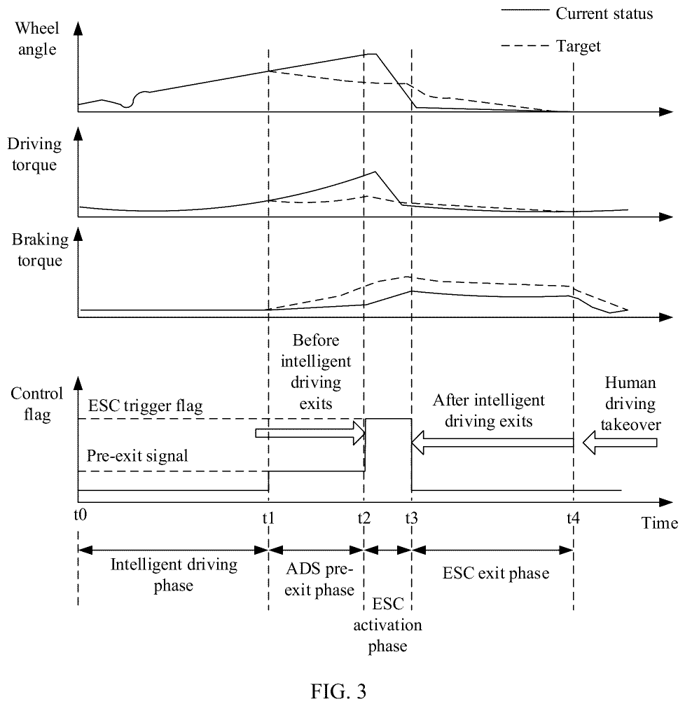

For example, as shown in FIG. 3, an embodiment of this application provides a schematic diagram of another traveling status of a vehicle. At a moment t0, the vehicle is in an intelligent driving phase, and the ADS normally takes over the vehicle. The vehicle management module imposes no limitation on the ADS, and the vehicle management module does not output the enabling flag bit of the pre-exit signal. In addition, under control of the ADS in the intelligent driving phase, no braking torque is applied to the vehicle, and a driving torque and a wheel angle of the vehicle gradually tend to increase. At a moment t1, after determining that the ESC activation probability is greater than the latch interval, the vehicle management module outputs the enabling flag bit of the pre-exit signal, and determines that the vehicle enters the ADS pre-exit phase. In the ADS pre-exit phase, taking over the vehicle by the ADS is limited by the vehicle management module. After receiving the pre-exit signal, the ADS performs a limiting measure. The limiting measure includes but is not limited to: limiting a further increase of the wheel angle, limiting a further increase of the driving torque, gradually increasing the braking torque, and slowly decelerating. After entering the ADS pre-exit phase at the moment t1, it indicates that a series of measures performed by the ADS in the ADS pre-exit phase fail to restore stability of the vehicle in time. As a result, a current value of the wheel angle is always greater than a target value and continuously increases, a current value of the driving torque is always greater than a target value and continuously increases, and a current value of the braking torque is less than a target value. In this way, the stability parameter of the vehicle meets the ESC activation condition at a moment t2, and the vehicle management module outputs an ESC trigger flag, activates the ESC, and simultaneously exits the ADS. That is, in a time period from the moment t1 to the moment t2, the vehicle is in the ADS pre-exit phase. After the moment t2, the vehicle is in the ESC activation phase, and in the ESC activation phase, the ADS has exited. At the moment t2, the ESC continuously reduces the wheel angle and the driving torque, and activates corresponding wheel cylinder pressurization to control the vehicle to restore stability. At a moment t3, when the current value of the wheel angle is less than the target value, the current value of the driving torque is less than the target value, and a difference between the current value and the target value of the braking torque is not large, the vehicle management module exits the ESC when determining that the stability parameter of the vehicle meets the stability condition. In this case, the ESC activation phase ends. At the moment t3, after the ESC exits, the vehicle management module determines that the vehicle enters an ESC exit phase, continuously reduces the wheel angle and the drive torque, and simultaneously maintains or reduces the braking pressure until the driver takes over the vehicle at a moment t4. In this case, the ESC exit phase ends. At the moment t4, the vehicle management module determines that the vehicle enters a human driving takeover mode.

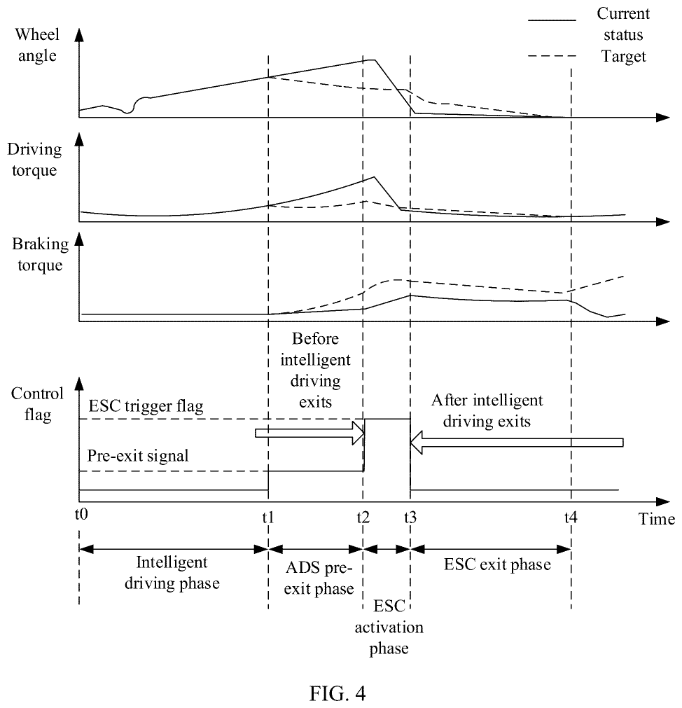

For another example, as shown in FIG. 4, an embodiment of this application provides a schematic diagram of still another traveling status of a vehicle. In a time period from a moment t0 to a moment t1 in FIG. 4, the vehicle is in an intelligent driving phase. In the intelligent driving phase, an execution process of the ADS and the vehicle management module is the same as the execution process corresponding to the time period from the moment t0 to the moment t1 in FIG. 3. In a time period from a moment t1 to a moment t2 in FIG. 4, the vehicle is in the ADS pre-exit phase. In the ADS pre-exit phase, an execution process of the ADS and the vehicle management module is the same as the execution process corresponding to the time period from the moment t1 to the moment t2 in FIG. 3. In a time period from a moment t2 to a moment t3 in FIG. 4, the vehicle is in an ESC activation phase. In the ESC activation phase, an execution process of the ESC and the vehicle management module is the same as the execution process corresponding to the time period from the moment t2 to the moment t3 in FIG. 3. At the moment t3, when a current value of the wheel angle in FIG. 4 is less than a target value, a current value of the driving torque is less than a target value, and a difference between a current value and a target value of the braking torque is not large, the vehicle management module exits the ESC when determining that the stability parameter of the vehicle meets the stability condition. In this case, the ESC activation phase ends. At the moment t3, after the ESC exits, the vehicle management module determines that the vehicle enters an ESC exit phase, continuously reduces the wheel angle and the driving torque, and simultaneously maintains or reduces the braking pressure. After determining that the driver does not take over the vehicle within a warning time corresponding to the warning signal, the vehicle management module maintains or reduces the braking torque, and simultaneously reduces the wheel angle and the driving torque to 0. The vehicle management module controls the vehicle to brake at a moment t4. After the moment t4, the vehicle is in a braking status, and the vehicle management module controls the braking torque to decrease.

In the foregoing embodiment, after determining that the intelligent driving function of the vehicle is enabled, the vehicle management module obtains the ESC activation probability, and determines, based on whether the ESC activation probability is greater than the latch interval, whether the traveling status of the vehicle is stable. When the ESC activation probability is greater than the latch interval, the vehicle management module outputs the warning signal to prompt the driver to take over the vehicle while outputting the pre-exit signal of the ADS and maintaining stability of the traveling status of the vehicle by using the ADS. In addition, when determining that the stability parameter of the vehicle meets the ESC activation condition, the vehicle management module activates the ESC, to provide a reaction time for the driver, thereby reducing a safety risk of taking over the vehicle by the driver after the ADS exits.

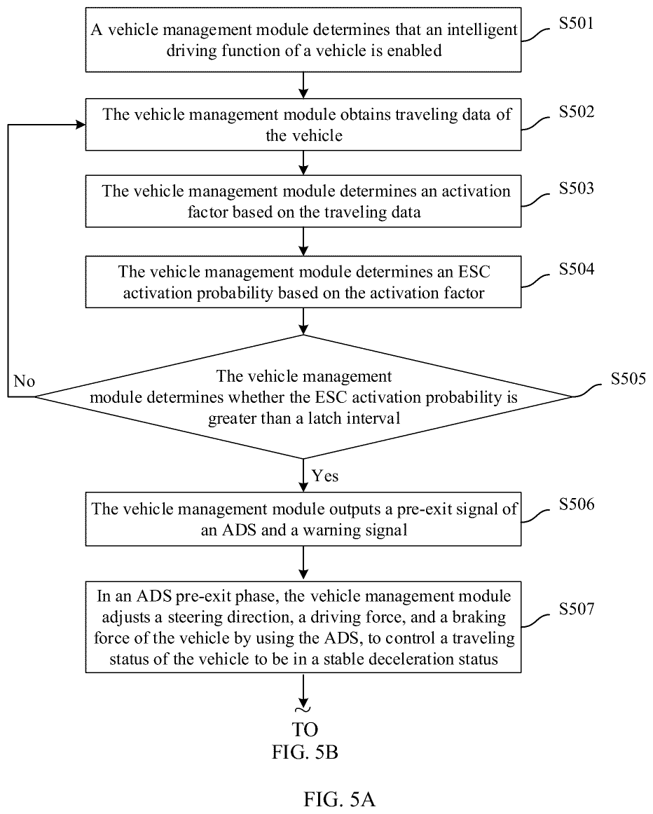

Based on the solution for activating an ESC of an intelligent driving vehicle shown in FIG. 1, the following continues to describe the solution by using an example in which the vehicle management module performs an ESC activation process. FIG. 5A to FIG. 5C are a schematic flowchart of a method for activating an ESC of an intelligent driving vehicle according to an embodiment of this application. The following describes a specific flow of this method with reference to FIG. 5A to FIG. 5C.

S501: The vehicle management module determines that an intelligent driving function of the vehicle is enabled.

S502: The vehicle management module obtains traveling data of the vehicle.

The traveling data includes but is not limited to: operation input information of a driver, vehicle status information obtained by a vehicle sensor, a driver image collected by an in-vehicle camera, and a road image and an environment image collected by a camera outside the vehicle. The operation input information of the driver includes but is not limited to: a steering wheel angle, a throttle pedal stroke, and a brake pedal stroke. The vehicle status information obtained by the sensor includes but is not limited to: horizontal and longitudinal accelerations, a wheel speed, a vehicle speed, a yaw angular velocity, a side-slip angle, and a wheel slip rate.

S503: The vehicle management module determines an activation factor based on the traveling data. The activation factor includes at least one parameter of a focus degree, a vehicle status parameter, and a road adhesion coefficient. The focus degree represents a capability of the driver to take over the vehicle after an ADS exits.

In an embodiment, a process in which the vehicle management module determines the activation factor based on the traveling data is the same as the process described in the embodiment corresponding to A1 in S101 in FIG. 1, and details are not described herein again.

S504: The vehicle management module determines an ESC activation probability based on the activation factor.

In an embodiment, the vehicle management module may perform weight normalization on the activation factor, to obtain the ESC activation probability.

S505: The vehicle management module determines whether the ESC activation probability is greater than a latch interval; and if the ESC activation probability is greater than the latch interval, the vehicle management module performs operation S506; or if the ESC activation probability is not greater than the latch interval, the vehicle management module performs operation S502.

S506: The vehicle management module outputs a pre-exit signal of the ADS and a warning signal. The pre-exit signal indicates the ADS to maintain stability of a traveling status of the vehicle, and the warning signal prompts the driver to take over the vehicle.

In some embodiments, the vehicle management module sends the pre-exit signal to the ADS, and determines that the vehicle enters an ADS pre-exit phase.

S507: In the ADS pre-exit phase, the vehicle management module adjusts a steering direction, a driving torque, and a braking torque of the vehicle by using the ADS, to control the traveling status of the vehicle to be in a stable deceleration status.

S508: The vehicle management module determines whether the ESC activation probability is less than the latch interval; and if the ESC activation probability is less than the latch interval, the vehicle management module performs operation S509; or if the ESC activation probability is not less than the latch interval, the vehicle management module performs operation S513.

S509: The vehicle management module collects statistics on duration in which the ESC activation probability is less than the latch interval.

S510: The vehicle management module determines whether the duration is greater than a time threshold; and if the duration is greater than the time threshold, the vehicle management module performs operation S511; or if the duration is not greater than the time threshold, the vehicle management module performs operation S508.

S511: The vehicle management module stops outputting the pre-exit signal and the warning signal.

S512: The vehicle management module determines that the vehicle travels based on the intelligent driving function.

S513: The vehicle management module obtains a stability parameter.

S514: The vehicle management module determines whether the stability parameter meets an ESC activation condition; and if the stability parameter meets the ESC activation condition, the vehicle management module performs operation S515; or if the stability parameter does not meet the ESC activation condition, the vehicle management module performs operation S508.

S515: The vehicle management module activates the ESC, determines that the vehicle enters an ESC activation phase, and exits the ADS.

S516: In the ESC activation phase, the vehicle management module adjusts the steering direction, the driving torque, and the braking torque of the vehicle by using the ESC, to control the traveling status of the vehicle to be in the stable deceleration status.

S517: The vehicle management module obtains the stability parameter.

S518: The vehicle management module determines whether the stability parameter meets a stability condition; and if the stability parameter does not meet the stability condition, the vehicle management module performs operation S517; or if the stability parameter meets the stability condition, the vehicle management module performs operation S519.

S519: The vehicle management module exits the ESC, and enters an ESC exit phase.

S520: In the ESC exit phase, the vehicle management module adjusts the steering direction, the driving torque, and the braking torque of the vehicle, to control the traveling status of the vehicle to be in the stable deceleration status.

S521. The vehicle management module determines whether the driver takes over the vehicle in a warning time period after the warning signal is output; and if the driver does not take over the vehicle in the warning time period after the warning signal is output, the vehicle management module performs operation S522; or if the driver takes over the vehicle in the warning time period after the warning signal is output, the vehicle management module performs operation S523.

S522: The vehicle management module controls the vehicle to brake.

S523: The vehicle management module determines that the vehicle is in a human driving mode.

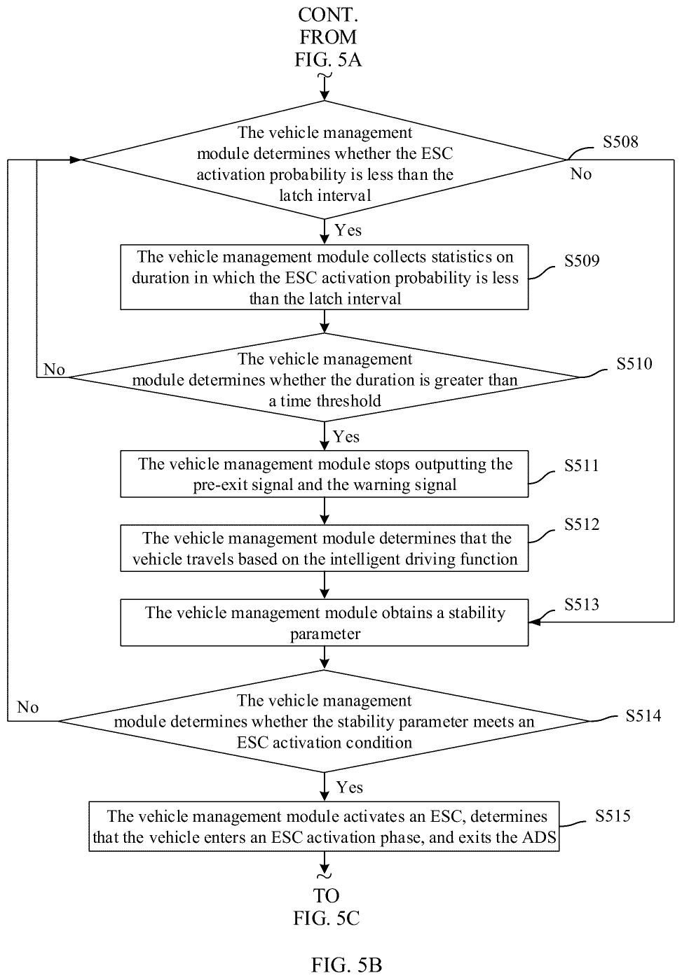

Based on a same inventive concept, an embodiment of this application further provides an ESC activation system. The ESC activation system may be located in a vehicle management module, or may be located in another processing module, and is used in an intelligent driving vehicle. As shown in FIG. 6, the ESC activation system includes: a detection unit, a decision-making unit, a switching control unit, and an execution unit.

The detection unit may be configured to: sense a surrounding environment of a vehicle, detect a vehicle status, and monitor a driver status.

In an embodiment, the detection unit may further include a signal collection unit, a data processing unit, and an information storage unit, as shown in FIG. 6. The information collection unit is configured to obtain a signal on a vehicle bus in real time. The data processing unit determines a current status parameter of the vehicle based on the obtained signal in combination with vehicle historical status information that is in the information storage unit. The detection unit may further determine to output a focus degree of a driver and a road adhesion coefficient based on sensor data by using the data processing unit. For example, the detection unit may fuse sensor data collected by sensors such as a visual camera, a millimeter-wave radar, and a laser radar, and output parameters such as the focus degree and the road adhesion coefficient by using a neural network algorithm and status estimation. The information storage unit is configured to store the signal obtained by the signal collection unit and a parameter obtained by the data processing unit through processing.

The decision-making unit is configured to: determine an ESC activation probability, and output a pre-exit signal of an ADS based on the ESC activation probability.

In an embodiment, the decision-making unit may further include a probability calculation unit and a determining unit, as shown in FIG. 6. The probability calculation unit is configured to calculate the ESC activation probability in a current status based on the parameters output by the detection unit. The determining unit is configured to determine whether the ESC activation probability output by the ESC activation probability calculation unit is greater than a preset latch interval. When determining that the ESC activation probability is greater than the latch interval, the determining unit outputs the pre-exit signal of the ADS, so that the ADS receives the pre-exit signal and maintains stability of the traveling status of the vehicle. A warning signal is output. In this case, the ESC activation system considers that there is a high probability that the ESC is activated. When the warning signal is output, the driver may be warned in advance before the ADS exits, and the driver is prompted to take over the vehicle, so as to reduce a safety risk of taking over the vehicle by the driver.

The switching control unit is configured to: switch a vehicle mode, maintain stability of the traveling status of the vehicle, and control the vehicle to brake.

In an embodiment, the switching control unit may further include a warning unit, as shown in FIG. 6. After receiving the pre-exit signal output by the determining unit, the warning unit outputs the warning signal, to warn the driver in advance before the ADS exits, so as to prompt the driver to take over the vehicle. In an embodiment, in a working process, a form in which the warning unit sends the warning signal to the driver to prompt the driver to take over the vehicle includes but is not limited to: seat shake, voice prompt, image prompt, and the like. In addition, the warning unit may further increase warning strength as a warning time increases, until the driver completely takes over the vehicle, or after enabling of the pre-exit signal is eliminated, enabling of the warning signal is automatically eliminated, or the driver manually eliminates the warning signal.

In an embodiment, the switching control unit may further include a coordination control unit, as shown in FIG. 6. After the decision-making unit outputs the pre-exit signal to the coordination control unit, before the ADS exits, the coordination control unit maintains stability of the traveling status of the vehicle by using the ADS. For example, before the ADS exits, the coordination control unit may send, to the ADS, internal information triggered by the ESC, as an input for the ADS to plan and control the traveling status of the vehicle, so that the ADS maintains stability of the traveling status of the vehicle by limiting a steering direction, a driving torque, and a braking torque of the vehicle.

In the process of outputting the pre-exit signal by the decision-making unit, the probability calculation unit calculates the ESC activation probability in real time, and the determining unit determines in real time whether the ESC activation probability is greater than the latch interval. When the determining unit determines that the ESC activation probability is still greater than the latch interval, the detection unit obtains a stability parameter of the vehicle, and determines whether the stability parameter meets an ESC activation condition. After the stability parameter meets the ESC activation condition, the determining unit activates the ESC and exits the ADS.

In an embodiment, after the ESC is activated and the ADS exits, the coordination control unit in the switching control unit maintains stability of the traveling status of the vehicle by using the ESC. For example, the ESC may slowly brake to reduce a vehicle speed by reducing a wheel angle, reducing a longitudinal driving torque, and increasing a lateral force, so as to maintain stability of the traveling status of the vehicle. After the traveling status of the vehicle tends to be stable and the ESC exits, the switching control unit may maintain stability of the traveling status of the vehicle until the driver takes over the vehicle, or the switching control unit controls the vehicle to brake.

The execution unit adjusts the vehicle based on limitation information output by the switching control unit. For example, the execution unit includes but is not limited to an ESP power steering motor, a drive motor control unit, and a braking hydraulic control unit. The ESP power steering motor adjusts a current angle of the vehicle based on an angle requirement in the limitation information. The drive motor control unit adjusts a current driving torque of the vehicle based on a driving requirement in the limitation information. The braking hydraulic control unit adjusts a current braking torque of the vehicle based on a braking requirement in the limitation information. In addition, the execution unit may further display the limitation information in a display interface, and notify the driver of content such as a current limitation on the vehicle.

In some embodiments, the signal collection unit obtains traveling data of the vehicle, and transmits the traveling data to the data processing unit. The data processing unit determines an activation factor based on the received traveling data. The probability calculation unit in the decision-making unit determines the ESC activation probability based on the received activation factor, and sends the determined ESC activation probability to the determining unit. When determining that the ESC activation probability is greater than the latch interval, the determining unit sends the warning signal to the warning unit in the switching control unit, and sends the pre-exit signal to the coordination control unit in the switching control unit. The warning unit warns the driver based on the received warning signal. The coordination control unit maintains, based on the received pre-exit signal, stability of the traveling status of the vehicle by using the ADS. In this case, in a process in which the decision-making unit outputs the pre-exit signal, the probability calculation unit calculates the ESC activation probability in real time. When the determining unit determines that the ESC activation probability is still greater than the latch interval, the determining unit receives the stability parameter of the vehicle obtained by the detection unit. When the stability parameter meets the ESC activation condition, the determining unit activates the ESC and exits the ADS. When the determining unit determines that the stability parameter satisfies a stability condition, the determining unit exits the ESC. In addition, after determining that the ESC exits, the coordination control unit sends the limitation information to the execution unit, to maintain stability of the traveling status of the vehicle until the driver takes over the vehicle, or controls the vehicle to brake when it is determined that the driver does not take over the vehicle.

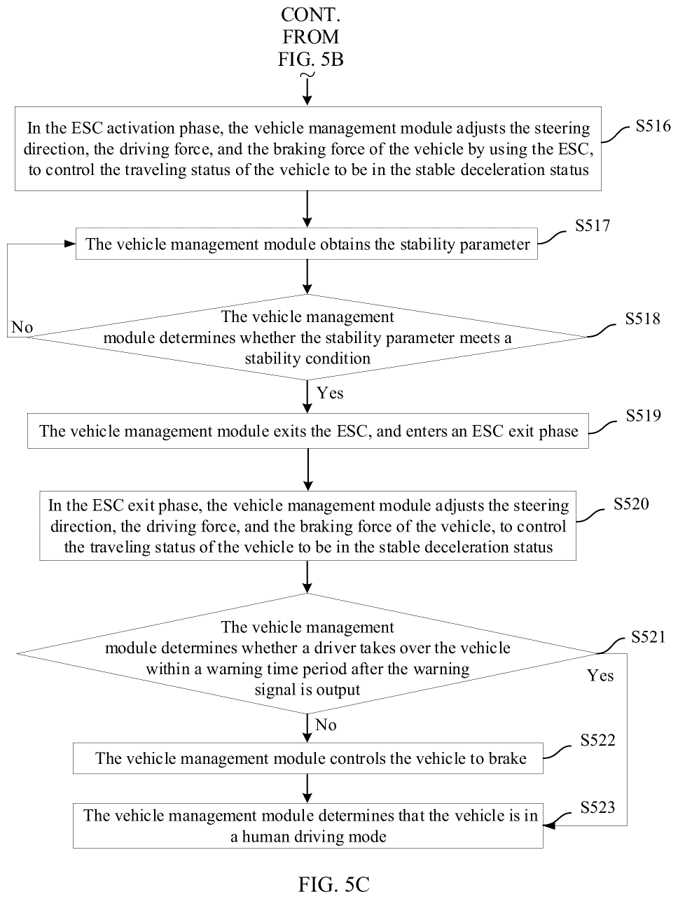

Based on a same technical concept, an embodiment of this application further provides an apparatus for activating an ESC of an intelligent driving vehicle. As shown in FIG. 7, the ESC activation apparatus 700 may include:
a first obtaining unit 701, configured to obtain an ESC activation probability after an intelligent driving function of the vehicle is enabled;
an output unit 702, configured to output a pre-exit signal of an autonomous driving system ADS and a warning signal when the ESC activation probability is greater than a preset latch interval, where the pre-exit signal indicates the ADS to maintain stability of a traveling status of the vehicle, and the warning signal prompts a driver to take over the vehicle;
a second obtaining unit 703, configured to obtain a stability parameter of the vehicle, where the stability parameter represents a stability characteristic of the traveling status of the vehicle; and
an activation unit 704, configured to activate the ESC when the stability parameter meets an ESC activation condition.

In an embodiment, the first obtaining unit 701 is configured to:
obtain traveling data of the vehicle; and
determine the ESC activation probability based on the traveling data.

In an embodiment, the first obtaining unit 701 is configured to:
determine an activation factor based on the traveling data, where the activation factor includes at least one parameter of a focus degree, a vehicle status parameter, and a road adhesion coefficient, and the focus degree represents a capability of the driver to take over the vehicle after the ADS exits; and
determine the ESC activation probability based on the activation factor.

In an embodiment, the first obtaining unit 701 is configured to:
perform weight normalization on the activation factor, to obtain the ESC activation probability.

In an embodiment, the output unit 702 is configured to:
send the pre-exit signal to the ADS, and determine that the vehicle enters an ADS pre-exit phase; and
adjust a steering direction, a driving torque, and a braking torque of the vehicle by using the ADS, to control the traveling status of the vehicle to be in a stable deceleration status.

In an embodiment, after the pre-exit signal of the autonomous driving system ADS and the warning signal are output, the second obtaining unit 703 is further configured to:
determine whether the ESC activation probability is less than the latch interval; and
obtain the stability parameter if the ESC activation probability is greater than the latch interval, or the ESC activation probability is within the latch interval; or
collect statistics on duration in which the ESC activation probability is less than the latch interval if the ESC activation probability is less than the latch interval; and stop outputting the pre-exit signal and the warning signal when the duration is greater than a time threshold.

In an embodiment, the activation unit 704 is configured to:
activate the ESC, determine that the vehicle enters an ESC activation phase, and exit the ADS;
adjust the steering direction, the driving torque, and the braking torque of the vehicle by using the ESC in the ESC activation phase, to control the traveling status of the vehicle to be in the stable deceleration status; and
obtain the stability parameter, and determine whether the stability parameter meets a stability condition; and exit the ESC if the stability parameter meets the stability condition.

In an embodiment, after exiting the ESC, the activation unit 704 is further configured to:
adjust the steering direction, the driving torque, and the braking torque of the vehicle, to control the traveling status of the vehicle to be in the stable deceleration status;
determine whether the driver takes over the vehicle within a warning time period after the warning signal is output; and
control the vehicle to brake if the driver does not take over the vehicle within the warning time period.

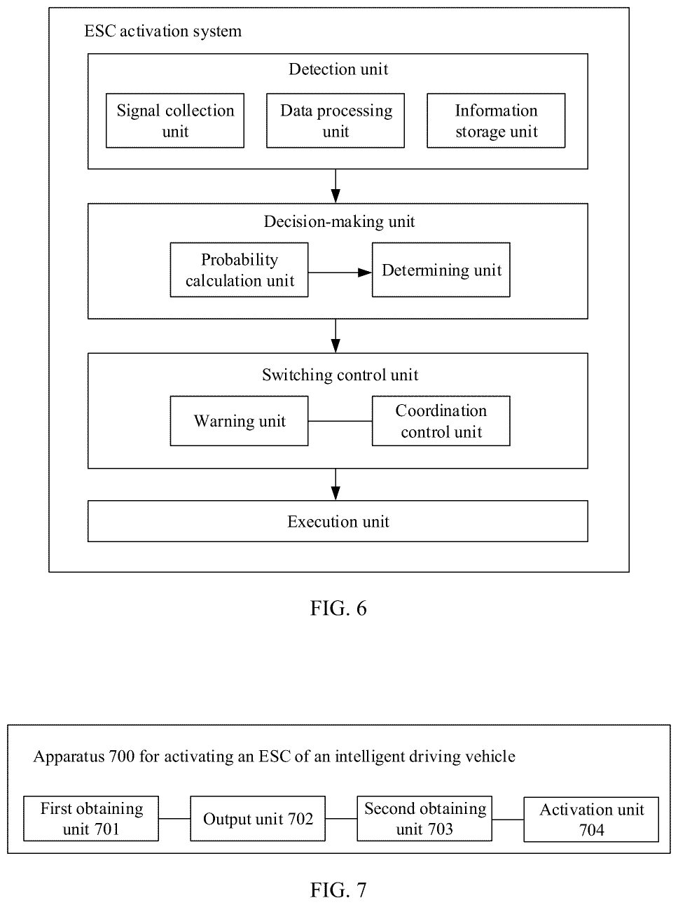

As shown in FIG. 8, an embodiment of this application provides a schematic diagram of a possible structure of an electronic device. The electronic device is applied to an intelligent driving vehicle. The structure of the electronic device is shown in FIG. 8, and includes a processor 801 and a memory 802. The memory stores one or more computer programs, and the one or more computer programs include instructions. When the processor invokes the instructions, the electronic device is enabled to perform the foregoing embodiments and the methods for activating an ESC of an intelligent driving vehicle provided in the foregoing embodiments.

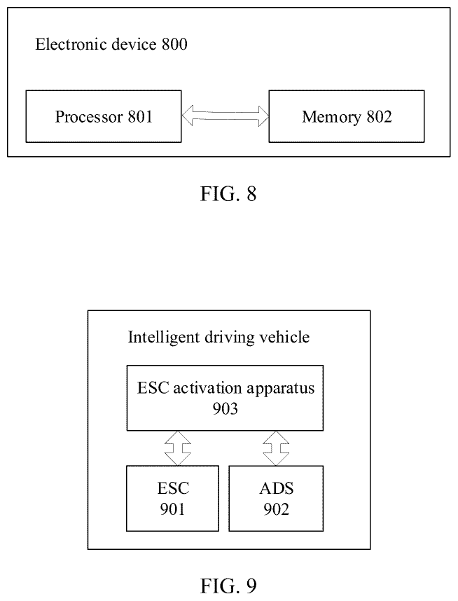

As shown in FIG. 9, an embodiment of this application provides a schematic diagram of a possible structure of an intelligent driving vehicle. The intelligent driving vehicle includes an ESC 901, an ADS 902, and an ESC activation apparatus 903. When the ADS 902 is activated, the ESC activation apparatus 903 performs the foregoing embodiments and the methods for activating an ESC of an intelligent driving vehicle provided in the foregoing embodiments.

Based on the foregoing content and a same concept, this application provides a computer-readable storage medium. The computer-readable storage medium stores a computer program or instructions. When the computer program or the instructions are executed, a computing device is enabled to perform the methods in the foregoing method embodiments.

Based on the foregoing content and a same concept, this application provides a computer program product. When a computer executes the computer program product, a computing device is enabled to perform the methods in the foregoing method embodiments.

It should be understood that, in embodiments of this application, division into modules is used as an example, and is merely logical function division. In an embodiment, another division manner may be used. In addition, functional modules in embodiments of this application may be integrated into one processor, or may exist alone physically, or two or more modules may be integrated into one module. The integrated module may be implemented in a form of hardware, or may be implemented in a form of a software functional module.

A person skilled in the art should understand that embodiments of this application may be provided as a method, a system, or a computer program product. Therefore, this application may use a form of a hardware-only embodiment, a software-only embodiment, or an embodiment with a combination of software and hardware. In addition, this application may use a form of a computer program product implemented on one or more computer-usable storage media (including but not limited to a disk memory, a CD-ROM, an optical memory, and the like) that include computer-usable program code.

This application is described with reference to the flowcharts and/or the block diagrams of the method, the device (system), and the computer program product according to this application. It should be understood that each procedure and/or block in the flowcharts and/or block diagrams, and combinations of the procedures and/or blocks in the flowcharts and/or block diagrams may be implemented by computer program instructions. These computer program instructions may be provided to a processor of a general-purpose computer, a special-purpose computer, an embedded processor, or another programmable data processing device to generate a machine, such that the instructions executed by the processor of the computer or another programmable data processing device generate an apparatus for implementing a specified function in one or more procedures in the flowcharts and/or one or more blocks in the block diagrams.

These computer program instructions may alternatively be stored in a computer-readable memory that can guide a computer or another programmable data processing device to work in a specific manner, so that the instructions stored in the computer-readable memory generate an artifact that includes an instruction apparatus. The instruction apparatus implements a specified function in one or more procedures in the flowcharts and/or one or more blocks in the block diagrams.

These computer program instructions may alternatively be loaded onto a computer or another programmable data processing device, so that a series of operations are performed on the computer or the other programmable data processing device, to generate computer-implemented processing. Therefore, the instructions executed on the computer or the other programmable device provide operations for implementing a specified function in one or more procedures in the flowcharts and/or in one or more blocks in the block diagrams.

It is clear that a person skilled in the art can make various modifications and variations to this application without departing from the protection scope of this application. In this way, this application is also intended to cover these modifications and variations, provided that these modifications and variations of this application fall within the scope of protection defined by claims of this application and their equivalent technologies.

1. A method for activating a chassis electronic stability controller (ESC) of an intelligent driving vehicle, the method comprising:
obtaining an ESC activation probability after an intelligent driving function of the intelligent driving vehicle is enabled;
outputting a pre-exit signal of an autonomous driving system (ADS) and a warning signal when the ESC activation probability is greater than a preset latch interval, wherein the pre-exit signal indicates the ADS to maintain stability of a traveling status of the intelligent driving vehicle, and the warning signal prompts a driver to take over the intelligent driving vehicle;
obtaining a stability parameter of the intelligent driving vehicle, wherein the stability parameter represents a stability characteristic of the traveling status of the intelligent driving vehicle; and
activating the ESC of the intelligent driving vehicle when the stability parameter meets an ESC activation condition.

2. The method according to claim 1, wherein obtaining the ESC activation probability comprises:
obtaining traveling data of the intelligent driving vehicle; and
determining the ESC activation probability based on the traveling data.

3. The method according to claim 2, wherein determining the ESC activation probability comprises:
determining an activation factor based on the traveling data, wherein the activation factor comprises at least one of a focus degree, a vehicle status parameter, or a road adhesion coefficient, and the focus degree represents a capability of the driver to take over the intelligent driving vehicle after the ADS exits; and
determining the ESC activation probability based on the activation factor.

4. The method according to claim 3, wherein determining the ESC activation probability based on the activation factor comprises:
performing weight normalization on the activation factor, to obtain the ESC activation probability.

5. The method according to claim 1, wherein outputting the pre-exit signal of the ADS comprises:
sending the pre-exit signal to the ADS, and determining that the intelligent driving vehicle enters an ADS pre-exit phase; and
adjusting a steering direction, a driving torque, and a braking torque of the intelligent driving vehicle using the ADS, to control the traveling status of the intelligent driving vehicle to be in a stable deceleration status.

6. The method according to claim 1, wherein after outputting the pre-exit signal of the ADS and the warning signal, the method further comprises:
determining whether the ESC activation probability is less than the preset latch interval; and
obtaining the stability parameter of the intelligent driving vehicle if the ESC activation probability is greater than the preset latch interval, or the ESC activation probability is within the preset latch interval; or
collecting statistics on a duration in which the ESC activation probability is less than the preset latch interval if the ESC activation probability is less than the preset latch interval; and
stopping outputting the pre-exit signal and the warning signal when the duration is greater than a time threshold.

7. The method according to claim 1, wherein activating the ESC of the intelligent driving vehicle comprises:
activating the ESC of the intelligent driving vehicle, determining that the intelligent driving vehicle enters an ESC activation phase, and exiting the ADS;
adjusting a steering direction, a driving torque, and a braking torque of the intelligent driving vehicle using the ESC in the ESC activation phase, to control the traveling status of the intelligent driving vehicle to be in a stable deceleration status; and
obtaining the stability parameter of the intelligent driving vehicle, and determining whether the stability parameter meets a stability condition; and exiting the ESC if the stability parameter meets the stability condition.

8. The method according to claim 7, wherein after exiting the ESC, the method further comprises:
adjusting the steering direction, the driving torque, and the braking torque of the intelligent driving vehicle, to control the traveling status of the intelligent driving vehicle to be in the stable deceleration status;
determining whether the driver takes over the intelligent driving vehicle within a warning time period after the warning signal is outputted; and
controlling the intelligent driving vehicle to brake if the driver does not take over the intelligent driving vehicle within the warning time period.

9. An apparatus for activating a chassis electronic stability controller (ESC) of an intelligent driving vehicle, the apparatus comprising:
processor; and
a memory storing a plurality of processor-executable instructions that, when executed by the processor, cause the processor to perform operations comprising:
obtaining an ESC activation probability after an intelligent driving function of the intelligent driving vehicle is enabled;
outputting a pre-exit signal of an autonomous driving system (ADS) and a warning signal when the ESC activation probability is greater than a preset latch interval, wherein the pre-exit signal indicates the ADS to maintain stability of a traveling status of the intelligent driving vehicle, and the warning signal prompts a driver to take over the intelligent driving vehicle; obtaining a stability parameter of the intelligent driving vehicle, wherein the stability parameter represents a stability characteristic of the traveling status of the intelligent driving vehicle; and
activating the ESC of the intelligent driving vehicle when the stability parameter meets an ESC activation condition.

10. The apparatus according to claim 9, wherein obtaining the ESC activation probability comprises:
obtaining traveling data of the intelligent driving vehicle; and
determining the ESC activation probability based on the traveling data.

11. The apparatus according to claim 10, wherein determining the ESC activation probability comprises:
determining an activation factor based on the traveling data, wherein the activation factor comprises at least one of a focus degree, a vehicle status parameter, or a road adhesion coefficient, and the focus degree represents a capability of the driver to take over the intelligent driving vehicle after the ADS exits; and
determining the ESC activation probability based on the activation factor.

12. The apparatus according to claim 11, wherein determining the ESC activation probability based on the activation factor comprises:
performing weight normalization on the activation factor, to obtain the ESC activation probability.

13. The apparatus according to claim 9, wherein outputting the pre-exit signal of the ADS comprises:
sending the pre-exit signal to the ADS, and determining that the intelligent driving vehicle enters an ADS pre-exit phase; and
adjusting a steering direction, a driving torque, and a braking torque of the intelligent driving vehicle by using the ADS, to control the traveling status of the intelligent driving vehicle to be in a stable deceleration status.

14. The apparatus according to claim 9, wherein the operations further comprise:
after the pre-exit signal of the ADS and the warning signal are output,
determining whether the ESC activation probability is less than the preset latch interval; and
obtaining the stability parameter of the intelligent driving vehicle if the ESC activation probability is greater than the preset latch interval, or the ESC activation probability is within the preset latch interval; or
collecting statistics on a duration in which the ESC activation probability is less than the preset latch interval if the ESC activation probability is less than the preset latch interval; and
stopping outputting the pre-exit signal and the warning signal when the duration is greater than a time threshold.

15. The apparatus according to claim 9, wherein activating the ESC of the intelligent driving vehicle comprises:
activating the ESC of the intelligent driving vehicle, determining that the intelligent driving vehicle enters an ESC activation phase, and exiting the ADS;
adjusting a steering direction, a driving torque, and a braking torque of the intelligent driving vehicle using the ESC in the ESC activation phase, to control the traveling status of the intelligent driving vehicle to be in a stable deceleration status; and
obtaining the stability parameter of the intelligent driving vehicle, and determining whether the stability parameter meets a stability condition; and exiting the ESC if the stability parameter meets the stability condition.

16. The apparatus according to claim 15, wherein the operations further comprise: after exiting the ESC,
adjusting the steering direction, the driving torque, and the braking torque of the intelligent driving vehicle, to control the traveling status of the intelligent driving vehicle to be in the stable deceleration status;
determining whether the driver takes over the intelligent driving vehicle within a warning time period after the warning signal is outputted; and
controlling the intelligent driving vehicle to brake if the driver does not take over the intelligent driving vehicle within the warning time period.

17. An intelligent driving vehicle, comprising a chassis electronic stability controller (ESC), an autonomous driving system (ADS), and the apparatus according to claim 9.

18. A non-transitory computer-readable storage medium, comprising computer program instructions, which when executed by a computer, cause the computer to perform operations comprising:
obtaining an electronic stability controller (ESC) activation probability after an intelligent driving function of an intelligent driving vehicle is enabled;
outputting a pre-exit signal of an autonomous driving system (ADS) and a warning signal when the ESC activation probability is greater than a preset latch interval, wherein the pre-exit signal indicates the ADS to maintain stability of a traveling status of the intelligent driving vehicle, and the warning signal prompts a driver to take over the intelligent driving vehicle;
obtaining a stability parameter of the intelligent driving vehicle, wherein the stability parameter represents a stability characteristic of the traveling status of the intelligent driving vehicle; and
activating the ESC of the intelligent driving vehicle when the stability parameter meets an ESC activation condition.
